(19) United States
(12) Patent Application Publication
(10) Pub. No.: US 2011/0161790 A1
(43) Pub. Date: Jun. 30, 2011

(54) METHOD AND SYSTEM FOR DISPLAYING ADVERTISEMENTS ON A MOBILE DEVICE

(76) Inventors: Joao Loureiro Junior, Campinas (BR); Wesley Elias Ribeiro, Paulinia (BR); Alexandre Novaes Olivieri, Campinas (BR); Tim Van Goethem, Crystal Lake, IL (US)

(21) Appl. No.: 12/649,723

(22) Filed: Dec. 30, 2009

(51) Int. Cl. G06F 17/00; G06Q 30/00; G06F 3/048

(52) U.S. Cl. 715/205; 705/14.64; 715/244; 715/764

(57) ABSTRACT

The present invention relates to methods of providing advertisement images on mobile devices, and to mobile devices capable of performing such methods. In at least one embodiment, a method includes accessing graphical advertisement information pertaining to the advertisement image to be presented on a mobile device display, wherein the information includes at least one type of information, analyzing one or more of the at least one type of information, and selecting a position for the advertisement image to be displayed on the display. The method also includes determining whether a gap exists or will exist in relation to portion(s) of the advertisement image, and displaying the advertising image, where at least some pixels situated in the gap are set to a determined color that is based at least in part upon the analyzing. In additional embodiments, advertisement images are displayed during interface wait times, and/or for minimum impression times.

### FIELD OF THE INVENTION

The present invention relates to mobile devices and, more particularly, to the display of media such as advertisements on mobile devices.

### BACKGROUND OF THE INVENTION

Mobile devices such as cellular telephones, smart phones and other handheld or portable electronic devices such as personal digital assistants (PDAs), etc. have become popular and ubiquitous. The increased functionality of mobile devices has enabled users to view an increasing amount and number of types of media on the display of a mobile device, such as videos, websites, text messages, etc. Advertisers have recognized such increasing media-exposure to users, and have sought to take advantage of the “face time” this offers. In particular in this regard, advertisers have tried, and continued to try, to develop methods and mechanisms by which advertisements (e.g., pop-up ads) can be displayed on mobile devices along with such media being displayed on the mobile devices.

Although there already exist numerous such methods and mechanisms by which advertisements are displayed on mobile devices, as a result of the variations in display sizes and operating systems on different mobile devices, among other things, displaying advertisements in desirable manners is often difficult. It can be difficult to display advertisements in manners that are effective in terms of facilitating user viewing of the advertisements, communicating advertising messages to users, and/or presenting aesthetically-pleasing advertising content that is complementary to (rather than conflicting with respect to) the displayed media content. In particular, as the display size of a mobile device is particularly small, users of mobile devices commonly dislike advertisements that consume large portions of the display, even for a short period of time, much less for extended periods of time.

It would therefore be advantageous if improved method(s) of displaying advertising information on mobile devices, and/or improved mobile devices capable of performing such method(s), could be developed. It would further be advantageous if, in at least some such embodiments, the improved method(s) of displaying advertising information achieved enhanced performance in terms of one or more of the considerations discussed above.

### SUMMARY OF THE INVENTION

In at least one embodiment, the present invention relates to a method of providing an advertisement image on a mobile device. The method includes accessing graphical advertisement information pertaining to the advertisement image to be presented on a mobile device display, where the graphical advertisement information includes at least one of image portion information, text portion information, and border portion information. The method also includes analyzing at least one of the image portion, text portion and border portion information, and selecting a position for the advertisement image to be displayed on the display. The method further includes determining whether a gap exists or will exist between an outer border of the advertisement image when displayed on the display and an edge of the display, or within the outer border of the advertisement image outside of one or both of an image portion and a text portion of the advertising image. The method additionally includes displaying the advertising image on the display, where at least some pixels situated in the gap on the display are set to a determined color, the determined color being based at least in part upon the analyzing.

Further, in at least some additional embodiments, the present invention relates to a mobile device. The mobile device includes a processing device, and a memory device in communication with the processing device. The mobile device also includes a transceiver also in communication with the processing device and configured to conduct communications with the interne, the communications including at least a first communication by which graphical advertising information is downloaded to the mobile device, and a display in communication with the processing device and configured to output an advertisement image based upon the graphical advertising information. The processing device determines when user interaction with the mobile device has been at least partly blocked and, during a time period while the user interaction remains at least partly blocked, causes the display to output the advertising image.

Additionally, in at least some further embodiments, the present invention relates to a method of providing an advertisement image on a mobile device. The method includes accessing graphical advertisement information pertaining to the advertisement image, and monitoring user interaction with at least one application on the mobile device. The method also includes showing the advertisement image on a display of the mobile device when the user interaction is at least partially blocked by execution of the at least one application on the mobile device, and removing the advertisement image from the display when the user interaction is no longer blocked.

### BRIEF DESCRIPTION OF THE DRAWINGS

FIG. 1 is a schematic drawing showing an example mobile device with an example dynamic advertisement on a display of the mobile device;

FIG. 2 is a block diagram showing example components of the mobile device of FIG. 1;

FIG. 3 is a flow chart showing various steps of an example process for accommodating an advertisement for display on the mobile device of FIG. 1; and

FIG. 4 is a flow chart showing various steps of an example process for displaying the advertisement of FIG. 3; and

FIG. 5 is an additional schematic drawing again showing the example mobile device of FIG. 1 with another example dynamic advertisement differing from that of FIG. 1.

### DETAILED DESCRIPTION OF THE INVENTION

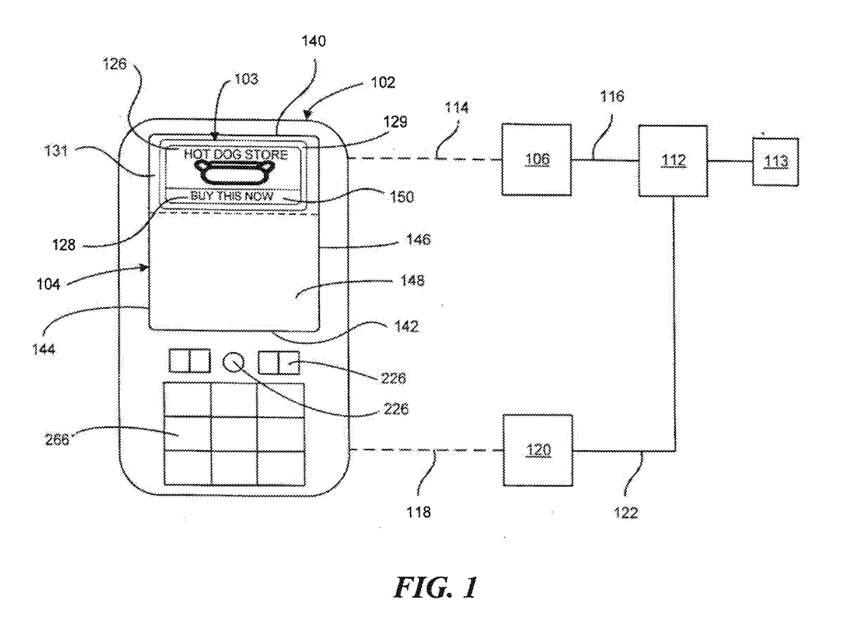

Referring to FIG. 1, an example mobile device 102 is shown on which an example advertisement image (or simply advertisement) 103 is displayed on a display 104, in accordance with an embodiment of the present invention. In the present embodiment, the mobile device 102 communicates with a cellular network 106 (which includes, for example, a cellular tower (not shown)) via a wireless communication link 114 and, by virtue of such communications with the cellular network, is further capable of communicating with the interne 112 via an additional communication link 116 shown to exist between the cellular network and the interne 112. Additionally as shown, the mobile device 102 can also communicate with the internet 112 independently of the cellular network 106 using a wireless connection 118 to a non-cellular-based system network 120. The non-cellular-based system network 120 can take any of a variety of forms, such as a wireless local area network (WLAN) that is in communication with the internet 112 via a communication link 122. Further, the wireless connection 118 can include, for example, communications transmitted over a network card or Bluetooth connection.

The mobile device 102 in the present embodiment is a personal digital assistant (PDA) although, in other embodiments, the mobile device can take the form of any of a variety of other types of wireless communication devices such as a cellular telephone, a smart phone, any of a variety of other cellular-based mobile devices having visual display capabilities, and/or other devices. In the present embodiment, the mobile device 102 communicates with the cellular network 106 via the link 114 in accordance with one or more data/voice standards, such as the third-generation (3G) and fourth generation (4G) standards. Also, the mobile device 102 can include one or more mobile operating systems, for example, Android, Linux, Iphone, or Windows Mobile. It will be understood that, by virtue of being in communication with the internet 112 via the links 114, 116, 118, 122, the mobile device 102 is further capable of being in communication with the “World Wide Web” and with numerous websites 113 forming a part thereof, including a variety of content provider websites (CPWs), such as various email services, search engines, social networking websites (SNWs), blogs, message boards, etc. To access and interface with the websites 113 via the internet 112, in the present embodiment, the mobile device 102 includes at least one internet interface application, such as a browser (Mozilla, Internet Explorer, etc.).

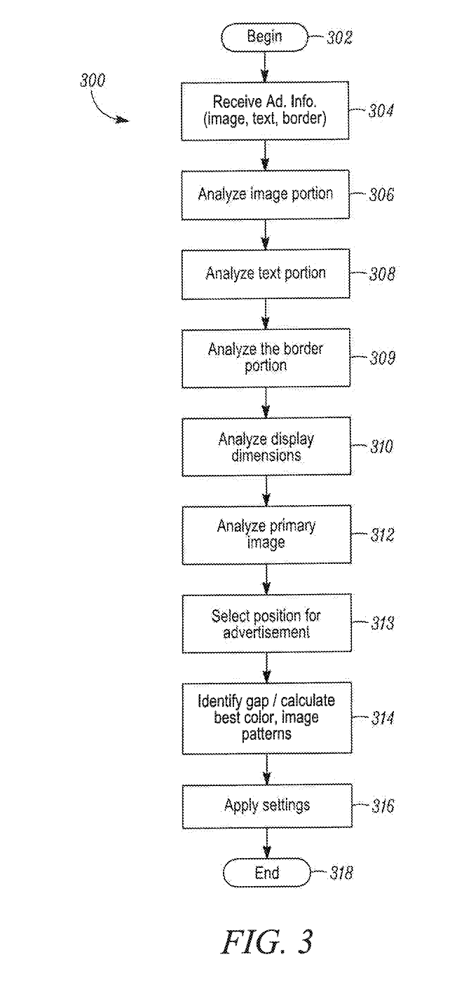

Still referring to FIG. 1, the display 104 of the mobile device 102 more particularly includes a top edge 140, a bottom edge 142, a left edge 144, and a right edge 146. As shown, by virtue of communications between the mobile device 102 and one or more of the websites 113 via the internet 112, the mobile device is able to access the website(s) 113 and download therefrom (or otherwise receive) content that can be used to generate both one or more advertisements such as an advertisement 103 and one or more content images such as a primary image 148. The content can particularly include graphical advertisement information used by the mobile device 102 to generate the advertisement 103 shown on the display 104. In some circumstances as shown both advertisements such as the advertisement 103 and content images such as the primary image 148 can be simultaneously displayed on the display 104 within the confines of the edges 140-146. As discussed below with respect to FIG. 3, in some such circumstances the advertisement 103 is configured for optimal display viewing and/or optimal display time on the mobile device 102, or both, given the presence of the primary image 148. The content for each of the advertisements and content images can be downloaded by way of any of a variety of processes including, for example, direct file download, streaming, caching, etc. As shown, the advertisement 103 in the present embodiment is image content that, when displayed, can include several different components including an ad image portion 126, an ad text portion 128, and an ad border portion 129. Depending upon the advertisement, the advertisement can be non-selectable or can be associated with a hyperlink that links the advertisement to an advertiser's website when selected by a user.

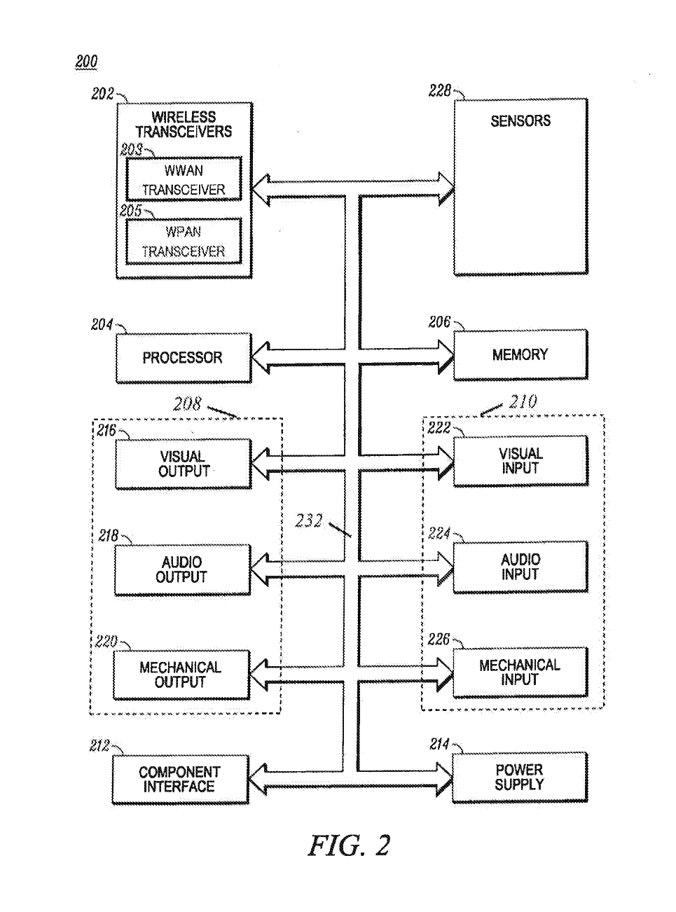

Referring now to FIG. 2, a block diagram is provided illustrating example internal components 200 of the mobile device 102. As shown in FIG. 2, the components 200 include one or more wireless transceivers 202, a processor 204 (e.g., a microprocessor, microcomputer, application-specific integrated circuit, etc.), a memory portion 206, one or more output devices 208, and one or more input devices 210. In at least some embodiments, a user interface is present that comprises one or more of the output devices 208 and one or more of the input devices 210. The internal components 200 can further include a component interface 212 to provide a direct connection to auxiliary components or accessories for additional or enhanced functionality. Additionally, the internal components also include one or more sensors 228. In the present embodiment, the component interface 212 can also be understood as a port by which the mobile device can be directly coupled (e.g., by way of a cable or connector/plug) to a computer (not shown). The internal components 200 can also include a power supply 214, such as a battery, for providing power to the other internal components while enabling the device to be portable. All of the internal components 200 can be coupled to one another, and in communication with one another, by way of one or more internal communication links 232 (e.g., an internal bus).

Each of the wireless transceivers 202 utilizes a wireless technology for communication which can include, for example (but are not limited to), cellular-based communication technologies such as analog communications (using AMPS), digital communications (using CDMA, TDMA, GSM, iDEN, 3G, GPRS, EDGE, etc.), and next-generation communications (using UMTS, WCDMA, 4G, LTE, IEEE 802.16, etc.) or variants thereof, or peer-to-peer or ad hoc communication technologies such as HomeRF (radio frequency), Bluetooth, wireless local area network (WLAN) protocols such as IEEE 802.11 (a, b, g or n), or other wireless communication technologies such as infrared technology. In the present embodiment, the wireless transceivers 202 include a cellular transceiver 203 (e.g., WWAN transceiver) and a WLAN transceiver 205, although in other embodiments only one of these types of wireless transceivers and/or other types of wireless transceiver(s) can be present. As already noted, in the present embodiment, the wireless transceivers 202 allow for communication with both the cellular network 106 of FIG. 1 and also the non-cellular-based system network 120. However, in other embodiments, the wireless transceiver 202 allow for communication only with one or the other of these networks, or allows for communication with multiple ones of one or both of these types of networks.

Example operation of the wireless transceivers 202 in conjunction with others of the internal components 200 of the mobile device 102 can take a variety of forms and can include, for example, operation in which, upon reception of wireless signals, the internal components detect communication signals and the transceiver 202 demodulates the communication signals to recover incoming information, such as voice and/or data, transmitted by the wireless signals. After receiving the incoming information from the transceiver 202, the processor 204 formats the incoming information for the one or more output devices 208. Likewise, for transmission of wireless signals, the processor 204 formats outgoing information, which may or may not be activated by the input devices 210, and conveys the outgoing information to one or more of the wireless transceivers 202 for modulation to communication signals. The wireless transceivers 202 convey the modulated signals by way of wireless communication links to the cellular network, which in turn conveys communications to the Internet 112.

Depending upon the embodiment, the input and output devices 208, 210 of the internal components 200 can include a variety of visual, audio and/or mechanical outputs. For example, the output device(s) 208 can include one or more visual output devices 216 such as a liquid crystal display and light emitting diode indicator, one or more audio output devices 218 such as a speaker, alarm and/or buzzer, and/or one or more mechanical output devices 220 such as a vibrating mechanism. The visual output devices 216 among other things can include a video display. Likewise, by example, the input device(s) 210 can include one or more visual input devices 222 such as an optical sensor (for example, a camera), one or more audio input devices 224 such as a microphone, and one or more mechanical input devices 226 such as a flip sensor, keyboard, keypad, selection button, navigation cluster, touch pad, touchscreen, capacitive sensor, motion sensor, and switch. Actions that can actuate one or more of the input devices 210 can include not only the physical pressing/actuation of buttons or other actuators, but can also include, for example, opening the device, unlocking the device, moving the device to actuate a motion, moving the device to actuate a location positioning system, and operating the device.

As for the sensors 228, these can include any of a variety of sensors. For example, the sensors 228 can include one or more proximity sensors (e.g., a light detecting sensor, an ultrasound transceiver or an infrared transceiver), touch sensors, altitude sensors, and/or a location circuit that can include, for example, a Global Positioning System (GPS) receiver, a triangulation receiver, an accelerometer, a tilt sensor, a gyroscope, or any other information collecting device that can identify a current location or user-device interface (carry mode) of the mobile device 102. Further, the memory portion 206 of the internal components 200 can encompass one or more memory devices of any of a variety of forms (e.g., read-only memory, random access memory, static random access memory, dynamic random access memory, etc.), and can be used by the processor 204 to store and retrieve data. It will be understood that the data that is stored by the memory portion 206 can include, but need not be limited to, instructions/code governing operation of an operating system, and applications, as well as informational data.

Each operating system 206 in particular can include executable code that controls basic functions of the mobile device, such as interaction among the various components included among the internal components 200, communication with external devices via the wireless transceivers 202 and/or the component interface 212, and storage and retrieval of applications and data, to and from the memory portion 206. In the present embodiment, the processor 204 is configured to run the one or more operating systems. As for the applications utilized by the mobile device 102, each application includes executable code that utilizes one or more of the operating systems to provide more specific functionality for the mobile device 102, such as file system service and handling of protected and unprotected data stored in the memory portion 206. In the present embodiment, the operating systems are configured to run a plurality of the applications, such as a web browser, etc. that allow for interaction between the mobile device and one or more of the websites 113 available via the internet 112. As for informational data, that is non-executable code or information that can be referenced and/or manipulated by an operating system or application for performing functions of the mobile device. The informational data can include content such as the aforementioned graphical advertisement information used to generate advertisements such as the advertisement 103, as well as other content information used to generate content images such as the primary image 148.

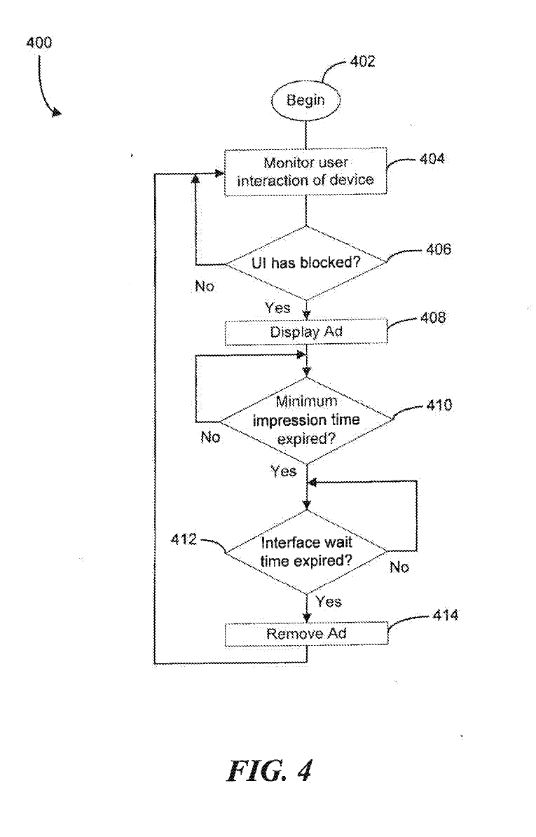

Turning now to FIGS. 3 and 4, in some embodiments the present invention is intended to encompass various methods of operation of the mobile device 102 by which the mobile device is able to display advertisements such as the advertisement 103 of FIG. 1 in dynamic manners (e.g., as dynamic advertisements) that facilitate the meeting of one or more objectives. These objectives can include, for example, facilitating user viewing of the advertisements, presenting advertisements in a more aesthetically-pleasing manner, and/or presenting advertisements in a manner that is not at all, or only minimally, conflictive with the presentation of other information such as the primary image 148 on the mobile device. As described in further detail below, FIG. 3 more particularly relates to a method of operation of the mobile device 102 that allows for configuration of the advertisement 103 for presentation on the display 104, and/or configuration of other portions of the display, in manners such that the presentation of the advertisement 103 takes on a more aesthetically-pleasing appearance, and one which may facilitate user viewing of the advertisement as well. By comparison, FIG. 4 more particularly relates to a method of operation of the mobile device 102 by which the advertisement 103 is particularly displayed at one or more times when such display does not conflict with the display of other content images such as the primary image 148, or conflicts to only a marginal or minimal extent.

Referring then specifically to FIG. 3, there is provided a flow chart that includes various example steps of a process 300 for configuring advertisements such as the advertisement 103 for optimal display on the display 104 of the mobile device 102 given the presence of the primary image 148. Upon the process 300 beginning at step 302, at step 304 the mobile device 102 downloads the content of (e.g., the graphical advertisement information used to generate) the advertisement 103. As discussed above, downloading can include accessing and/or receiving the content for the advertisement 103 from the interne 112 or another network source (with the content originating, for example, at one or more of the websites 113). Also, such downloading can further include accessing a previously-downloaded (e.g., cached) content for the advertisement 103 that is already resident on the mobile device 102. In the present embodiment, the downloaded content for the advertisement 103 includes content forming each of the image portion 126, the text portion 128, and the border portion 129. The image portion 126 can include one or more of various components, for example, a graphic design (e.g., logo), a background, letters, symbols, and numbers, where each component is comprised of singular or multiple colors. The text portion 128 can also include letters, numbers, and/or other symbols each having one or more colors. Further, the border portion 129 provides a visible or invisible frame about the image portion 126 and the text portion 128. The border portion 129 provides a user selection demarcation between the advertisement 103 and adjacent non-advertising image(s) displayed on the mobile device 102. The border portion 129 identifies which area on the display 104 can be associated with any hyperlink for the advertisement 103.

Referring still to FIG. 3, at step 306, 308 and 309, the image portion 126, text portion 128 and border portion 129 are respectively analyzed. The analysis is performed at least in part to aid in determining a fill color, as discussed in further detail below. In at least some embodiments, one or more algorithms are utilized to analyze various characteristics of the image portion 126, text portion 128, and border portion 129. For example, with respect to analyzing the image portion 126 at step 306, in some embodiments this includes performing algorithm(s) to determine the dimensions of the image portion 126, and/or to determine the strength (e.g., quantity) and/or location of various pixel color(s) of the image portion, or average values of those characteristics. Additionally, in some embodiments the analyzing of the text portion 128 at step 308 includes performing algorithm(s) to determine various text characteristics such as the size, the predominant pixel color, and the intended positioning of the text portion (and particularly the letters, numbers, and/or other symbols, etc. of the text portion) relative to the image portion 126. Further, in some embodiments, the analyzing of the border portion 129 at step 309 includes performing algorithm(s) to determine how the size parameters of the advertisement 103 compare to the size of the display 104 (and possibly any other images displayed thereon) as discussed below, as well as determining the pixel color(s) of the border portion 129. Next, at step 310, the dimensions of the display 104 are analyzed using the edge parameters. Further, at step 312, the pixel colors of the primary image 148 on the display 104 are analyzed to identify the strength (e.g., the quantity of pixels with similar colors) of the pixel colors. Additionally, at step 313, a location on the display 104 is selected for the advertisement 103 to be displayed.

Once the location of the advertisement 103 has been established, then at step 314 the size of the border portion 129 of the advertisement 103 is compared with the size of the section of the display 104 not occupied by the primary image 148, in order to identify any gaps existing between the advertisement 103 and that section of the display. Assuming that gap area(s) do exist, best color and/or image patterns can be determined for placement within such gap area(s). More particularly, in one embodiment, a fill color can be provided in the gap areas to provide a more desirable appearance of the advertisement 103 on the display 104. For example, with respect to FIG. 1, the advertisement 103 is shown to be too small to extend from the left edge 144 to the right edge 146, or from the top edge 140 to the upper edge of the primary image 148 (as represented by a dashed line), and consequently a gap 131 exists between the border and each of these edges. That being the case, it can be desirable to fill the gap 131 by changing the pixel color of the display 104 in the gap to a fill color that provides a more aesthetically pleasing appearance. The fill color can be determined based upon a variety of factors, including one or more characteristics determined during the analyses performed at the steps 306, 308, 309 and 312. For example, the fill color can be selected to match the predominant pixel color of the advertisement 103, or one or more of the portion 126, 128, 129 thereof, so that the gap appears as a seamless (or relatively seamless) extension of the advertisement 103 or otherwise matches in some manner one or more aspects of the advertisement. Further for example, in addition to using a predominant pixel color, the fill color for the gap 131 can be another complimentary or contrasting fill color to help the advertisement 103 blend with or stand out against the background pixel color(s) of the primary image 148.

Aspects of the advertisement 103 itself can also be adjusted based upon characteristics of the advertisement, the primary image 148 and/or one or more desired characteristics of the gap 131. Step 314 is thus also intended to encompass determinations regarding best color and/or image patterns for the advertisement itself. For example, assuming that the gap 131 fill color is determined based upon the text portion 128, which is often provided as a portion of text that does not include an initial background, an additional fill color can be generated and provided as background for the text of the text portion 128, for example, within a background region 150 of the text portion as shown in FIG. 1. Also for example, the background region 150 of the text portion 128 can be determined in consideration of other factors such as those determined by way of the analyses described above, such as the predominant pixel color of the primary image 148, the predominant pixel color of the image portion 126, the predominant pixel color of the text portion 128, and predominant color of the border portion 129. In at least one embodiment, the fill color for the background region 150 of the text portion 128 is chosen to match the predominant pixel color of the image portion 126 so as to conjoin the portions 126, 128. That said, in such embodiments, when the predominant pixel color of the image portion 126 is similar to the predominant pixel color for the text portion 128, then a different color is selected for the background region 150 to allow the text to be more visible against the background region.

Once step 314 has been completed, and best color or image patterns for any gap and/or any portion of the advertisement itself have been determined, the process finally advances to step 316. At step 316, the processing device causes the display 104 to display the gap(s) 131 in accordance with the best color or image patterns as determined at step 314. For example, assuming that one or more fill color(s) have been determined for the gap(s) 131 at step 314, once such fill color(s) have been selected for regions such as the gap(s) 131, the fill colors are applied to the display 104 by modifying the color of the pixels within associated with those gap(s). Likewise, if changes should be made to aspects of the advertisement 103 itself (such as to the background region 150), at step 316 the advertisement is displayed in accordance with such instructions. Finally, upon completion of the step 316, the process 300 ends at step 318.

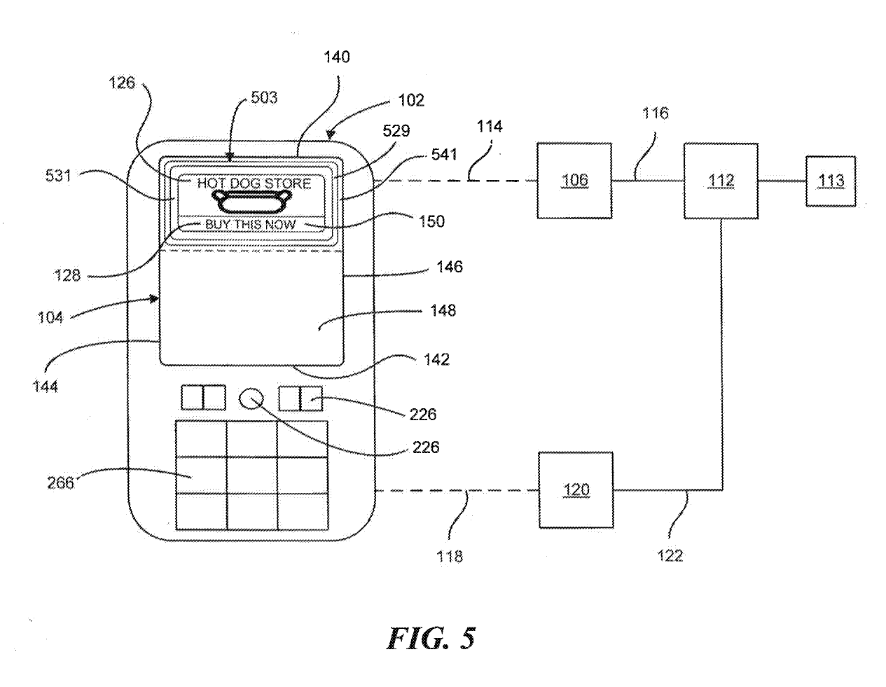

Notwithstanding the above description corresponding to the arrangement of the advertisement 103 as shown in FIG. 1, the present invention is also intended to encompass additional embodiments in which there are other arrangements of advertisements. For example, referring additionally to FIG. 5, the mobile device 102 of FIG. 1 is shown again to be in communication with the cellular network 106 and non-cellular-based system network 120 and thereby with the internet 112 (and websites 113). While identical to FIG. 1 in almost all respects, in FIG. 5 a different advertisement 503 is shown on the mobile device 102. Although the different advertisement 503 again includes the image portion 126 and the text portion 128 a shown in FIG. 1, the different advertisement 503 (instead of the border portion 129) has a border portion 529 that surrounds the image portion and text portion but that is spaced apart from those portions so as to define a gap 531. Thus, as shown, the border portion 529 extends circumferentially around the gap 531, and the gap 531 extends circumferentially around the combination of the image portion 126 and the text portion 128. It should further be noted that, in FIG. 5, the border portion 529 is still spaced apart from and within the edges of the display 104 (e.g., the edges 140, 142 144, 146) and also spaced apart from (above) the dashed line border of the primary image 148 shown on the display 104, such that a further gap 541 also exists between the border portion of the advertisement 503 and each of those edges as well as between the border portion and the primary image 148.

Given such an arrangement, the mobile device 102 can operate so as to modify the display of the gap 531 in various manners. Generally speaking, the process steps discussed above with respect to FIG. 3 pertaining to the modification of the color of pixels and/or image patterns within the gap 131 of FIG. 1 are equally or at least substantially applicable to the modification of the color of pixels and/or image patterns within the gap 531 of FIG. 5. That said, in applying the process steps of FIG. 3 with respect to a gap such as the gap 531 that is internal with respect to the border portion 529 rather than a gap such as the further gap 541 that is external of the border portion 529, it should be noted that certain steps of the process may be performed in a somewhat different manner than would be the case when addressing an external gap such as the further gap 541. For example, the step 314 involving identification of the gap 531 will involve determining the positioning of the border portion 529 relative to the image portion 126 and text portion 128 but may not at all involve any additional determination as to how the border portion 529 relates to the edges of the display 104 or the primary image 148 (albeit, in some circumstances, the positions of the edges of the display 104 and/or the position of the primary image 148 will indirectly affect the positioning of the border portion 529 relative to the image and text portions 126, 128 so as to affect the size or shape of the internal gap therebetween, and thus the relationship of the border portion 529 to the edges of the display and/or the primary image in such circumstances can still be taken into account).

Further, while in some embodiments an external gap such as the gap 541 exists between the border portion 529 and the edges 142, 144, 146, 148 of the display 104 and/or between the border portion and any primary image such as the primary image 148, this need not be the case in all embodiments. Rather, in some embodiments the border portion 529 abuts one or more of the edges (e.g., the edges of the display 140, 144, 146) of the display 104 and/or any primary image (e.g., the dashed line border of the primary image 148) such that an internal gap within the border portion such as the gap 531 is present but an external gap such as the further gap 541 is not present. Nevertheless, where a further gap such as the further gap 541 exists in addition to the gap 531, the process steps of FIG. 3 can be performed in some such embodiments to modify the display of the further gap 541 as well as to modify the display of the internal gap 531. However, in other such embodiments where the further gap 541 is present, the steps discussed above with respect to FIG. 3 are not implemented to adjust the display of the further gap 541, but rather other techniques (such as techniques pertaining to the display of the primary image 148) and/or other rules (e.g., layout rules for the display 104, which are independent of the advertising image attributes) govern the display of the gap 541.

Turning now to FIG. 4, an additional flow chart is provided showing various example steps of a process 400 for displaying an advertisement, such as the advertisement 103 of FIG. 1 as generated by way of the process 300 of FIG. 3. In the present embodiment, the advertisement 103 is displayed on the display 104 for one or more time periods that include(s) either an interface wait time or a minimum impression time, or both. An interface wait time can be understood as a period of time when the mobile device 102 has blocked user interaction due to application processing. Such a period of time can occur, for example, when a browser application operating on the mobile device 102 is conducting communications via the internet 112 with one of the websites 113 and there are delays in such communications (e.g., after some but not all data associated with a web page has been downloaded to the mobile device). Further for example, an example interface wait time can be (or include) the period of time transpiring between a user inputting a search request on a search engine application and the time that the search results are provided for display. During such an interface wait time, a user is commonly waiting and viewing the display 104 in anticipation of future interactions with the mobile device (e.g., viewing search results) even though interaction is currently precluded. Thus, although user interaction is blocked during such an interface wait time, during that time period it is still possible for information such as advertisements to be displayed on the display 102. Since the application processing is precluding user interaction, the display of the advertisement 103 during such time period does not detract (or at least does not detract substantially) from the user's interactive experience.

As for a minimum impression time, such a time period is the minimum time that an advertisement such as the advertisement 103 should remain visible on the display 104 so as to minimize flicker and to allow the user sufficient time to review the advertisement 103. The display of an advertisement such as the advertisement 103 for merely its minimum impression time is a practice that by definition causes minimal disruption to a user's experience. An advertisement can be displayed for its minimum impression time any and every time the advertisement is displayed. Although an advertisement can be displayed for only its minimum impression time when the advertisement is being displayed during an interface wait time, this need not be the case since the interface wait time may exceed the minimum impression time.

For any given advertisement such as the advertisement 103, the minimum impression time can be calculated (or estimated) based upon a variety of factors including, for example, the size of the advertisement and the amount of information (e.g., alphanumeric characters or words) on the advertisement. Additionally, or alternatively, the minimum impression time can be determined by the advertiser and provided to the mobile device 102 as part of the advertising platform protocol. In some such circumstances, a minimum impression time communicated as part of the advertising platform protocol will serve a suggested minimum impression time (rather than being mandatory) insofar as there may not be any ability on the part of an advertiser or other third party to enforce compliance with such a minimum impression time (e.g., a user can close a publishing application anytime). That said, it can be noted that for some experiences like interstitial (full screen) ads, such minimum impression time information coming from an advertiser can be very important for achieving display effects (for example, in a circumstance where the minimum wait time must be met before a “Play” button appears allowing a game to be launched).

More particularly with respect to FIG. 4, the example steps of the process 400 for displaying an advertisement such as the advertisement 103 begin at step 402. Upon commencement of the process, at step 404 the mobile device 102 operates and, more particularly as part of this operation, monitors user interaction with the mobile device. Next, at step 406, the mobile device further determines based upon its monitoring whether user interaction has been blocked by a wait time generated by an application running on the mobile device. Until such time as the mobile device 102 determines that user interaction has been blocked, the mobile device returns to step 404 and thus cycles repeatedly between steps 404 and 406. However, if at step 406, the mobile device 102 particularly determines user interaction to be blocked, then at step 408 the algorithm provides a signal to display an advertisement such as the advertisement 103. It will be understood that, in some circumstances, the interface wait time occurs when content image(s) such as the primary image 148 are already being displayed by the display 104 of the mobile device 102. When such content image(s) already are present, the advertisement 103 can occur in one or more of a variety of manners with respect to any content image(s) such as the primary image 148 already displayed on the display 104.

For example, depending upon the embodiment, the advertisement 103 can be embedded within the primary image 148 or overlaid upon the primary image, can displace the primary image, or even be placed in a window distinct form a window within which is provided the primary image More particularly, the advertisement 103 can be embedded in the primary image 148 so as to provide an integrated and less distracting appearance, can be overlaid on the existing image so as to cover the existing image and draw attention to the advertisement, can displace the existing image either by compression or shifting, or can be displayed within a window that differs from another window within which is positioned the primary image 148 (thus maintaining accessibility of the complete primary image). In addition, to further enhance the aesthetic appeal of the advertisement 103 or to minimize intrusion upon the primary image 148, in the present embodiment the advertisement 103 can be presented on the display 104 using animation that presents the advertisement in one of numerous manners such as sliding or fading onto the display. In particular, sliding can include the advertisement dropping from a portion of the display, such as the top edge 140, towards the bottom edge 142, so as to gradually move into view on the display. In other embodiments, the sliding can include the advertisement being revealed gradually from any of the display edges and extending in the direction of any other display edge.

In the present embodiment, the process 400 continues at step 410, wherein the mobile device 102 determines whether the advertisement 103 has remained in view on the display 104 for the minimum impression time. Until the minimum impression time has elapsed, the process 400 remains at the step 410 and continues to display the advertisement 410. Once the minimum impression time has elapsed, as determined at step 410, then at step 412 the mobile device 102 further determines whether the interface wait time also has elapsed. Until the interface wait time has elapsed, the process 400 remains at the step 412 and continues to display the advertisement. Once the interface wait time has elapsed, the process 400 advances to step 414, at which the mobile device 102 ceases to display the advertisement 103. The advertisement 103 can be removed from the display 104 in any one of a variety of manners. In some circumstances, such as where the primary image 148 was displayed prior to the display of the advertisement at step 408, the removal of the advertisement can be performed in a manner that is substantially the reverse of the manner in which the advertisement was first displayed at step 408, such as sliding the advertisement off the display opposite the manner in which it earlier slid onto the display.

In view of the above description pertaining to FIG. 4, it should be evident that, in circumstances where the minimum impression time exceeds the interface wait time, the minimum impression time will be the determining factor in terms of the amount of time the advertisement 103 is displayed, and vice-versa. Displaying the advertisement for a period of time as determined in this manner (by the minimum impression time and interface wait time) provides a less obtrusive method of advertising on a mobile device 102, as it substantially limits or eliminates the consumption of valuable display space when a user is capable of actively operating the device. Nevertheless, although the advertisement view time is limited, the user is provided the opportunity to select the advertisement to inquire further and can then be redirected to another website, or an additional browser window can be opened with the additional website being displayed thereby.

It should be noted that the processes 300 and 400 discussed above can, depending upon the embodiment, be utilized separately or together to display an advertisement on a mobile device 102. When the processes 300, 400 are performed in combination with one another in order to display an advertisement, the process 300 can begin and/or conclude at any one of numerous times relative to the process 400. For example, in one embodiment, the process 300 allows for the advertisement to be obtained, processed and cached for display prior to step 408, such that the advertisement can be substantially immediately displayed upon the occurrence of a user interaction interruption, thereby maximizing the proportion of the interface wait time during which that advertisement is successfully displayed. In other embodiments, the process 300 can begin when the process 400 is at step 406, when the existing image is displayed, thereby providing additional data to use to configure the advertisement for an effective and aesthetically pleasing display.

Notwithstanding the description provided above, the present invention is intended to encompass numerous variations of the above-described processes and other embodiments differing from those discussed above. For example, although the embodiment discussed with respect to FIG. 4 envisions that the advertisement 103 will be displayed at least for the larger of the minimum impression time and the interface wait time, in other embodiments only one of those times is considered in determining the display time. Indeed, in some alternate embodiments where interface wait times occur, advertisements such as the advertisement 103 can be displayed only for the length of the interface wait time, without concern for the minimum impression time of the advertisement. Also, in some alternate embodiments, advertisements such as the advertisement 103 are displayed for the minimum impression time even where the display of the advertisements occurs at times other than when there is a user interaction interruption. Additionally, although the displaying of an advertisement 103 is described above with reference to the interface wait time and the minimum impression time, in at least some other embodiments the advertisement can be presented for another time period, such as a pre-configured time. Further, depending upon the embodiment, the blocking of all or only some user interaction(s) with the mobile device (or application(s) running thereon) is sufficient to allow advertisements such as the advertisement 103 to be displayed on the mobile device display.

It is specifically intended that the present invention not be limited to the embodiments and illustrations contained herein, but include modified forms of those embodiments including portions of the embodiments and combinations of portions of different embodiments as come within the scope of the following claims.

We claim:

1. A method of providing an advertisement image on a mobile device, the method comprising:
accessing graphical advertisement information pertaining to the advertisement image to be presented on a mobile device display, wherein the graphical advertisement information includes at least one of image portion information, text portion information, and border portion information;
analyzing at least one of the image portion, text portion and border portion information;
selecting a position for the advertisement image to be displayed on the display;
determining whether a gap exists or will exist between an outer border of the advertisement image when displayed on the display and an edge of the display, or within the outer border of the advertisement image outside of one or both of an image portion and a text portion of the advertising image; and
displaying the advertising image on the display, wherein at least some pixels situated in the gap on the display are set to a determined color, the determined color being based at least in part upon the analyzing.

2. The method of claim 1, wherein it is determined that the gap exists or will exist within the outer border of the advertisement image outside of a combination section including the image portion and the text portion of the advertising image.

3. The method of claim 2 wherein, when the advertising image is displayed, the gap exists between a border region and the combination section, the border region extending inwardly from the outer border toward the combination section but not up to the combination section.

4. The method of claim 1, wherein the analyzing of the at least one portion includes analyzing pixel colors in at least one of the portions to determine a predominant pixel color.

5. The method of claim 4, wherein either (a) an additional color of the at least some pixels situated in the gap is changed to match the predominant pixel color, or (b) the analyzing of the pixel colors further includes analyzing a first pixel color of the text portion and providing a text portion background having a second pixel color in contrast with the first pixel color of the text portion.

6. The method of claim 1, further including providing a hyperlink as part of the advertisement image when presented on the display, wherein upon an indication being provided indicating selection of the hyperlink by a user, a communication signal is output from the mobile device that is configured to prompt establishment of communications between the mobile device and a website.

7. The method of claim 1, further comprising determining a position of a content image also presented on the display, and wherein the selecting of the position for the advertisement image is determined at least in part based upon the position of the content image.

8. The method of claim 1, further including
monitoring user interaction with at least one application on the mobile device;
displaying the advertisement image on the display after it is determined that the user interaction with the at least one application has been blocked; and
removing the advertisement image from the display at a subsequent time.

9. The method of claim 1, wherein the advertisement image is transitioned onto the display by showing the advertisement image to slide onto the display.

10. A mobile device comprising:
a processing device;
a memory device in communication with the processing device;
a transceiver also in communication with the processing device and configured to conduct communications with the interne, the communications including at least a first communication by which graphical advertising information is downloaded to the mobile device; and
a display in communication with the processing device and configured to output an advertisement image based upon the graphical advertising information,
wherein the processing device determines when user interaction with the mobile device has been at least partly blocked and, during a time period while the user interaction remains at least partly blocked, causes the display to output the advertising image.

11. The mobile device of claim 10, wherein the processing device causes the display to cease outputting the advertising image at or after a time at which the user interaction ceases being at least partly blocked.

12. The system of claim 10, wherein the processing device causes the display to output the advertising image beginning at a first time when the user interaction first becomes at least partly blocked, and wherein the processing device causes the display to cease outputting the advertising image at a second time subsequent to the first time, the second time occurring as either a time at which the user interaction ceases being at least partly blocked or a later time at which a minimum impression time period has elapsed relative to the first time.

13. The system of claim 10, wherein the processing device further causes the display to overlay at least a portion of an existing image output by the display with the advertising image when the advertising image is output.

14. The system of claim 10, wherein the processing device further analyzes at least one of an image portion, a text portion, and a border portion of the graphical advertising information to determine at least one color associated with the at least one portion and, based upon the analyzing of the at least one portion, the processing device causes the display to change at least one pixel color of at least one pixel within a gap region existing between an outer border of the advertising image when output by the display and an edge of the display or within the outer border of the advertisement image outside of a combination section including an image portion and a text portion of the advertising image.

15. The system of claim 10, wherein the processing device causes the display to output the advertising image while the user interaction remains entirely blocked, the blocking of the user interaction occurring while content information is downloaded by the mobile device from the internet.

16. A method of providing an advertisement image on a mobile device, the method comprising:
accessing graphical advertisement information pertaining to the advertisement image;
monitoring user interaction with at least one application on the mobile device;
showing the advertisement image on a display of the mobile device when the user interaction is at least partially blocked by execution of the at least one application on the mobile device; and
removing the advertisement image from the display when the user interaction is no longer blocked.

17. The method of claim 16, further including waiting for a minimum impression time to expire relative to a first time at which the advertisement image is first shown on the display, prior to the removing of the advertisement image from the display.

18. The method of claim 16, further including sliding the advertisement image into the display from at least one edge portion of the display towards another at least one edge portion, thus resulting in the showing of the advertisement image.

19. The method of claim 16, further including providing a hyperlink as part of the advertisement image, wherein upon an indication of a user selection of the hyperlink, the mobile device operates to enter into communications with a remote website determined by the hyperlink.

20. The method of claim 16, further including modifying an aspect of an existing image shown on the display to allow for the showing of the advertisement image, and positioning the advertisement image over at least a portion of the existing image shown on the display.
